(19) United States
(12) Patent Application Publication
(10) Pub. No.: US 2023/0066953 A1
(43) Pub. Date: Mar. 2, 2023

(54) BATTERY MODULE FOR ELECTRIC PASSENGER VEHICLE

(71) Applicant: Indiev, Inc, Los Angeles, CA (US)

(72) Inventor: Thomas Gage, Los Angeles, CA (US)

(21) Appl. No.: 17/458,953

(22) Filed: Aug. 27, 2021

(51) Int. Cl. H01M 50/213; H01M 50/502; B60L 50/64; H01M 10/6554; H01M 50/296; H01M 50/264

(52) U.S. Cl. CPC H01M 50/213; H01M 50/502; B60L 50/64; H01M 10/6554; H01M 50/296; H01M 50/264; H01M 2220/20

(57) ABSTRACT

Battery modules for electric passenger vehicles are provided. A battery module can include a bottom current collector assembly, a lower level positive cell tray, a lower level battery cell array, a lower level negative cell tray, a cooling plate, an upper level negative cell tray, an upper level battery cell array, an upper level positive cell tray, and a top current collector assembly. The battery module can further include side caps and main terminal holders. The battery module can easily be connected to another adjacent battery module and/or to a conductive line in a battery pack.

### BACKGROUND

Electric passenger vehicles are becoming more prevalent, leading to a need for better batteries for such vehicles. Existing batteries for electric passenger vehicles have many drawbacks.

### BRIEF SUMMARY

Embodiments of the subject invention provide novel and advantageous battery modules for electric passenger vehicles, as well as methods of using the same and methods of fabricating the same. A battery module can include a bottom current collector assembly, a lower level positive cell tray, a lower level battery cell array, a lower level negative cell tray, a cooling plate, an upper level negative cell tray, an upper level battery cell array, an upper level positive cell tray, and a top current collector assembly. The battery module can further include side caps and main terminal holders. The battery module can easily be connected to another adjacent battery module (e.g., through a middle interconnection at an end of the battery module) and/or to a conductive line in a battery pack (e.g., through a vertical interconnection). The battery module provides versatility and allows for compact current flow. The battery module can be adapted to a variety of configurations (e.g., by only changing the current collector design/configuration).

In an embodiment, a battery module can comprise: a bottom current collector assembly; a lower level positive cell tray disposed on the bottom current collector assembly; a lower level battery cell array disposed on the bottom current collector assembly (e.g., directly on the lower level positive cell tray); a lower level negative cell tray disposed on the bottom current collector assembly (e.g., directly on the lower level battery cell array); a cooling plate disposed on the bottom current collector assembly (e.g., directly on the lower level negative cell tray); an upper level negative cell tray disposed on the cooling plate; an upper level battery cell array disposed on the cooling plate (e.g., on the upper level negative cell tray); an upper level positive cell tray disposed on the cooling plate (e.g., on the upper level battery cell array); and a top current collector assembly disposed on the cooling plate (e.g., on the upper level positive cell tray). The battery module can further comprise side caps (e.g., scalloped side caps) covering respective lateral sides of the lower level positive cell tray, the lower level battery cell array, the lower level negative cell tray, the upper level negative cell tray, the upper level battery cell array, and/or the upper level positive cell tray. The battery module can further comprise main terminal holders on respective ends of the battery module. The battery module can further comprise an upper level center fastener (e.g., an upper level center bolt) that goes through respective holes of the top current collector assembly, the upper level positive cell tray, the upper level battery cell array, and/or the upper level negative cell tray. The battery module can further comprise a lower level center fastener that goes through respective holes of the bottom current collector assembly, the lower level positive cell tray, the lower level battery cell array, and/or the lower level negative cell tray. The battery module can comprise a stacked structure of the bottom current collector assembly, the lower level positive cell tray, the lower level battery cell array, the lower level negative cell tray, the cooling plate, the upper level negative cell tray, the upper level battery cell array, the upper level positive cell tray, and the top current collector assembly. The lower level positive cell tray can be disposed directly on and in direct contact with (e.g., with only an adhesive therebetween or in direct physical contact with) the bottom current collector assembly; the lower level battery cell array can be disposed directly on and in direct contact with (e.g., with only an adhesive therebetween or in direct physical contact with) the lower level positive cell tray; the lower level negative cell tray can be disposed directly on and in direct contact with (e.g., with only an adhesive therebetween or in direct physical contact with) the lower level battery cell array; the cooling plate can be disposed directly on and in direct contact with (e.g., with only an adhesive therebetween or in direct physical contact with) the lower level negative cell tray; the upper level negative cell tray can be disposed directly on and in direct contact with (e.g., with only an adhesive therebetween or in direct physical contact with) the cooling plate; the upper level battery cell array can be disposed directly on and in direct contact with (e.g., with only an adhesive therebetween or in direct physical contact with) the upper level negative cell tray; the upper level positive cell tray can be disposed directly on and in direct contact with (e.g., with only an adhesive therebetween or in direct physical contact with) the upper level battery cell array; and/or the top current collector assembly can be disposed directly on and in direct contact with (e.g., with only an adhesive therebetween or in direct physical contact with) the upper level positive cell tray. The cooling plate can comprise a top plate. The cooling plate can comprise grooves and dimples on an upper surface thereof. The cooling plate can comprise a first end protrusion protruding from a first end thereof and having a first post extending upwards therefrom, and a second end protrusion protruding from a second end thereof, opposite from the first end, and having a second post extending upwards therefrom. The cooling plate can comprise a first connector disposed on the first post and a second connector disposed on the second post. The battery module can further comprise at least one vertical interconnection at an end thereof. The cooling plate can have width-wise symmetry and/or length-wise symmetry. A width of the battery module, measured in a first direction along a longest edge of the upper level positive cell tray (the x-direction as depicted in the figures), can be in a range of from 0.5 feet to 2.5 feet. A length of the battery module, measured in a second direction perpendicular to a longest edge of the upper level positive cell tray and parallel to an upper surface of the cooling plate (the y-direction as depicted in the figures), can be in a range of from 0.5 feet to 2 feet. A thickness of the battery module, measured in a third direction perpendicular to an upper surface of the cooling plate (the z-direction as depicted in the figures), can be in a range of from 2 inches to 24 inches.

### BRIEF DESCRIPTION OF DRAWINGS

FIG. 1A shows an isometric view of a top of a battery module, according to an embodiment of the subject invention.

FIG. 1B shows an isometric view of a bottom of the battery module of FIG. 6A.

FIG. 2 shows an exploded view of a battery module, according to an embodiment of the subject invention.

FIG. 3A shows an isometric view of a cooling plate assembly (with a top plate) of a battery module, according to an embodiment of the subject invention.

FIG. 3B shows an isometric view of the cooling plate assembly of FIG. 8A, without the top plate.

FIG. 4 shows an isometric view of a pair of battery modules that can be disposed adjacent to and connected to each other (e.g., in a battery pack), according to an embodiment of the subject invention.

### DETAILED DESCRIPTION

Embodiments of the subject invention provide novel and advantageous battery modules for electric passenger vehicles, as well as methods of using the same and methods of fabricating the same. A battery module can include a bottom current collector assembly, a lower level positive cell tray, a lower level battery cell array, a lower level negative cell tray, a cooling plate, an upper level negative cell tray, an upper level battery cell array, an upper level positive cell tray, and a top current collector assembly. The battery module can further include side caps and main terminal holders. The battery module can easily be connected to another adjacent battery module (e.g., through a middle interconnection at an end of the battery module) and/or to a conductive line in a battery pack (e.g., through a vertical interconnection). The battery module provides versatility and allows for compact current flow. The battery module can be adapted to a variety of configurations (e.g., by only changing the current collector design/configuration).

The term “direct contact” as used herein when referring to two elements being in “direct contact” with each other refers to the case where the two elements have only an adhesive between them (with no other intervening elements) or are in direct physical contact with each other (with no intervening elements at all). The term “direct physical contact” as used herein when referring to two elements being in “direct physical contact” with each other refers to the case where the two elements are directly, physically contacted with each other such that there are no intervening elements at all.

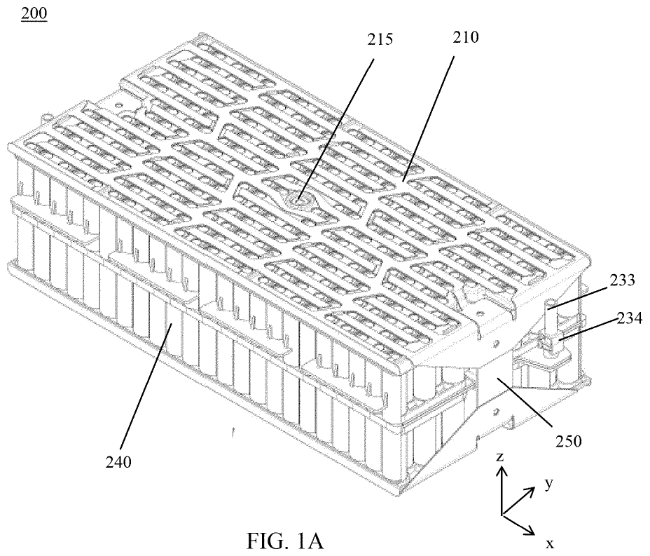

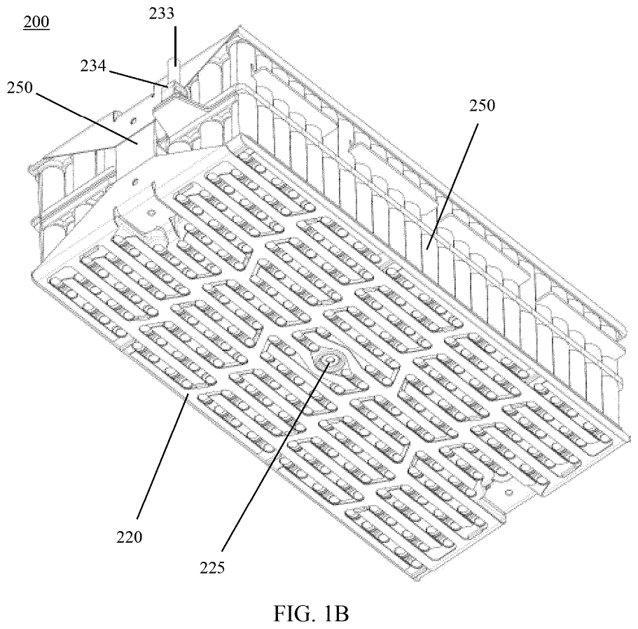

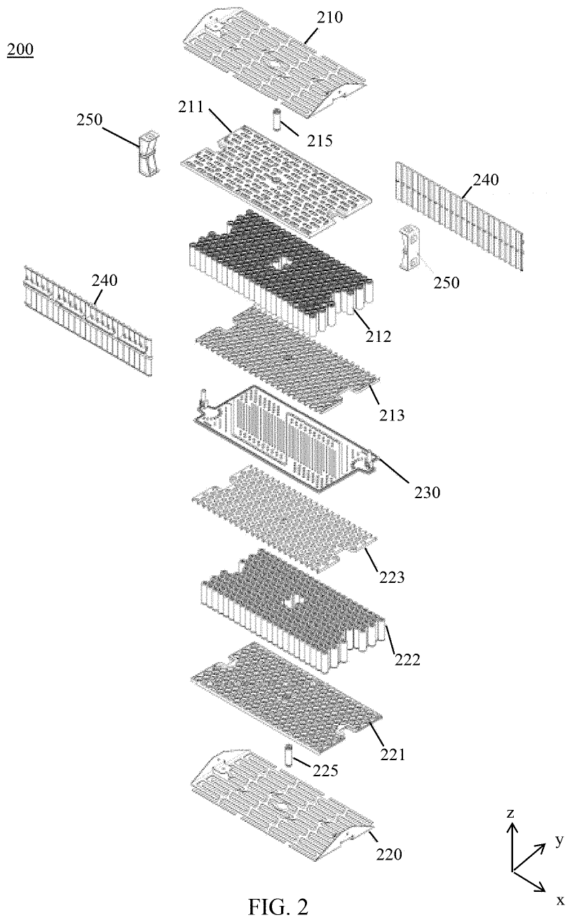

FIGS. 1A and 1B show isometric views of a top and a bottom, respectively, of a battery module according to an embodiment of the subject invention, and FIG. 2 shows an exploded view of the battery module. Referring to FIGS. 1A, 1B, and 2, a battery module 200 can include a cooling plate 230, an upper level negative cell tray 213 disposed on (and optionally in direct contact with or in direct physical contact with) the cooling plate 230, an upper level battery cell array 212 disposed on (and optionally in direct contact with or in direct physical contact with) the upper level negative cell tray 213, an upper level positive cell tray 211 disposed on (and optionally in direct contact with or in direct physical contact with) the upper level battery cell array 212, and a top current collector assembly 210 disposed on (and optionally in direct contact with or in direct physical contact with) the upper level positive cell tray 211. The battery module 200 can further include a bottom current collector assembly 220, a lower level positive cell tray 221 disposed on (and optionally in direct contact with or in direct physical contact with) the bottom current collector assembly 220, a lower level battery cell array 222 disposed on (and optionally in direct contact with or in direct physical contact with) the lower level positive cell tray 221, and a lower level negative cell tray 223 disposed on (and optionally in direct contact with or in direct physical contact with) the lower level battery cell array 222. The cooling plate 230 can be disposed on (and optionally in direct contact with or in direct physical contact with) the lower level negative cell tray 223. That is, the battery module 200 can have a stacked structure of the bottom current collector assembly 220, the lower level positive cell tray 221, the lower level battery cell array 222, the lower level negative cell tray 223, the cooling plate 230, the upper level negative cell tray 213, the upper level battery cell array 212, the upper level positive cell tray 211, and the top current collector assembly 210.

The battery module 200 can further include one or more main terminal holders 250 on respective ends (in the x-direction as depicted in the figures) of the battery module 200, as well as side caps 240 covering the respective lateral sides (covering from the y-direction as depicted in the figures) of the upper and lower level positive and negative trays 211, 213, 221, 223 and battery cell arrays 212, 222. The upper level portion of the battery module 200 can include an upper level center fastener 215 that can go through a hole of (and/or connect) the top current collector assembly 210, the upper level positive cell tray 211, the upper level battery cell array 212, and/or the upper level negative cell tray 213 (e.g., connect to each other). The lower level portion of the battery module 200 can include a lower level center fastener 225 that can go through a hole of (and/or connect) the bottom current collector assembly 220, the lower level positive cell tray 221, the lower level battery cell array 222, and/or the lower level negative cell tray 223 (e.g., connect to each other). Each of the upper level center fastener 215 (if present) and the lower level center fastener 225 (if present) may be any suitable fastener (e.g., screw, pin, bolt, rivet, anchor, nail). For example, the upper level center fastener 215 can be a bolt, and the lower level center fastener 225 can be a bolt. In an embodiment, a single center fastener (e.g., center tube and/or center bolt assembly) can go through respective holes of the top current collector assembly 210, the upper level positive cell tray 211, the upper level battery cell array 212, the upper level negative cell tray 213, the cooling plate 230, the lower level negative cell tray 223, the lower level battery cell array 222, the lower level positive cell tray 221, and the bottom current collector assembly 220 to clamp the entire battery module 200 together.

In an alternative embodiment, the upper level positive cell tray 211 and the upper level negative cell tray 213 can be switched, such that the upper level positive cell tray 211 is disposed between (and optionally in direct contact with or in direct physical contact with) the upper level battery cell array 212 and the top current collector assembly 210, and the upper level negative cell tray 213 is disposed between (and optionally in direct contact with or in direct physical contact with) the cooling tray 230 and the upper level battery cell array 212.

The side caps 240 can be, for example, scalloped side caps 240. The scalloped shape can allow for tight coupling with the battery arrays 212, 222 when the side caps 240 are put in position.

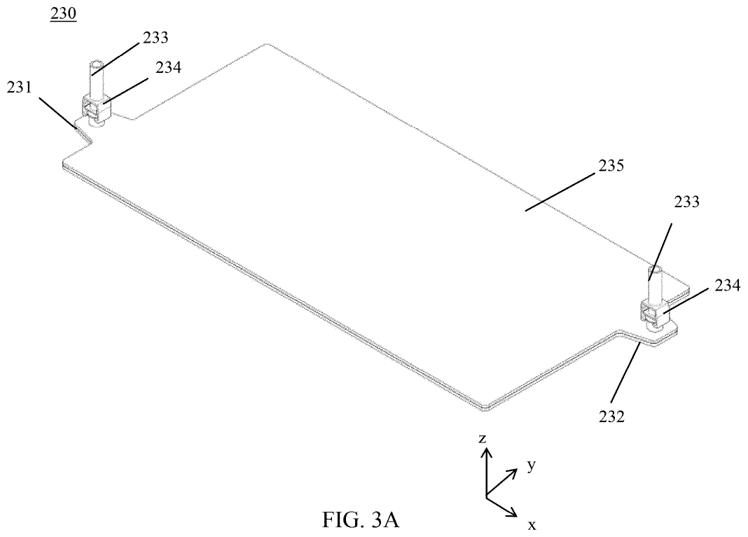

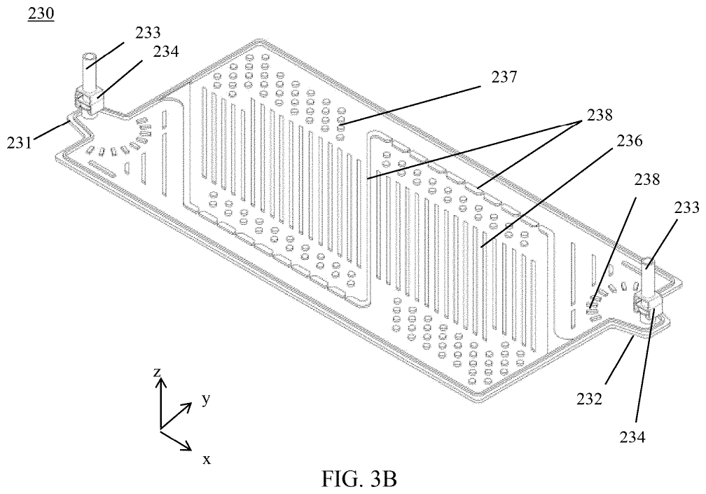

FIGS. 3A and 3B show isometric views of the cooling plate 230 with and without a top plate, respectively. Referring to FIGS. 3A and 3B, the cooling plate 230 of the battery module 200 can optionally include a top plate 235. The cooling plate 230 can include grooves 236, dimples 237, and/or other indentations or protrusions 238 on an upper and/or lower surface thereof. The cooling plate 230 can include a first end protrusion 231 and/or a second end protrusion 232 protruding from the respective ends thereof (in the x-direction as depicted in the figures). The end protrusions 231, 232 can include a post 233 and/or a connector 234 disposed thereon and extending in the thickness direction of the battery module (the z-direction as depicted in the figures), for example extending upwards towards the direction of the top current collector assembly 210 (or downwards towards the direction of the bottom current collector assembly 220). The posts 233 can be used as, for example, a means of providing coolant and/or coolant flow to the battery module 200.

Any (but not all within the same embodiment) of the bottom current collector assembly 220, the lower level positive cell tray 221, the lower level battery cell array 222, the lower level negative cell tray 223, the cooling plate 230, the upper level negative cell tray 213, the upper level battery cell array 212, the upper level positive cell tray 211, the top current collector assembly 210, the upper level center fastener 215, the lower level center fastener 225, the side caps 240, and the main terminal holders 250 can be made of a conductive material. Of course, the upper level battery cell array 212 and/or the lower level battery cell array 222 can include an electrolyte and/or other battery material. In some embodiments, the upper level center fastener 215, the lower level center fastener 225, the side caps 240, the main terminal holders 250, and/or the cooling plate 230 may optionally comprise non-conductive materials.

The battery module 200 can have a width (in the x-direction as depicted in the figures) of any of the following values, at least any of the following values, at most any of the following values, or any range or subrange having any of the following values as endpoints (all values are in feet (ft)): 0.1, 0.2, 0.3, 0.4, 0.5, 1, 1.5, 2, 2.5, 3, 3.5, 4, 4.5, or 5. For example, the width of the battery module can be in a range of from 0.5 ft to 2.5 ft.

The battery module 200 can have a length (in the y-direction as depicted in the figures) of any of the following values, at least any of the following values, at most any of the following values, or any range or subrange having any of the following values as endpoints (all values are in ft): 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.5, 3, 3.5, 4, 4.5, or 5. For example, the length of the battery module can be in a range of from 0.5 ft to 2 ft.

The battery module 200 can have a thickness (in the z-direction as depicted in the figures) of any of the following values, at least any of the following values, at most any of the following values, or any range or subrange having any of the following values as endpoints (all values are in inches (in)): 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 19, 20, 21, 22, 23, or 24. For example, the thickness of the battery module can be in a range of from 2 in to 12 in (e.g., from 2 in to 8 in).

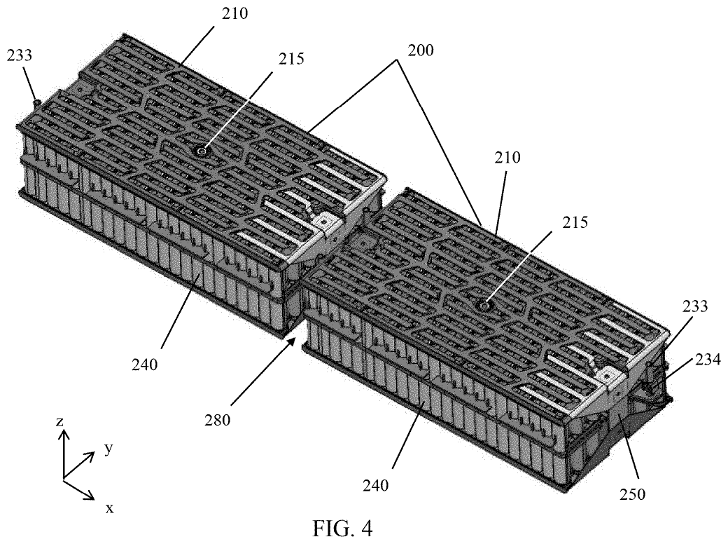

FIG. 4 shows an isometric view of a pair of battery modules 200 that can be disposed adjacent to each other (and/or electrically connected to each other) (e.g., in a battery pack).

Referring to FIG. 4, the battery modules 200 can be disposed side-by-side in the width direction (the x-direction as depicted in the figures). The battery modules 200 can be electrically connected to each other (e.g., via a middle interconnection 280 between (in the x-direction as depicted in the figures) the two battery modules 200. The battery modules 200 can also include at least one vertical interconnection at an end of at least one battery module 200 of the interconnected pair of battery modules 200. This can be used to connect to at least one conductive line (not pictured) of a battery pack that can connect to one or more contacts that can be used to connect such a battery pack to the electric passenger vehicle to provide battery power thereto.

The transitional term “comprising,” “comprises,” or “comprise” is inclusive or open-ended and does not exclude additional, unrecited elements or method steps. By contrast, the transitional phrase “consisting of” excludes any element, step, or ingredient not specified in the claim. The phrases “consisting” or “consists essentially of” indicate that the claim encompasses embodiments containing the specified materials or steps and those that do not materially affect the basic and novel characteristic(s) of the claim. Use of the term “comprising” contemplates other embodiments that “consist” or “consisting essentially of” the recited component(s).

When ranges are used herein, combinations and subcombinations of ranges (e.g., subranges within the disclosed range), specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

The subject invention includes, but is not limited to, the following exemplified embodiments.

Embodiment 1. A battery module, comprising:

a bottom current collector assembly;

a lower level positive cell tray disposed on the bottom current collector assembly;

a lower level battery cell array disposed on the bottom current collector assembly (e.g., directly on the lower level positive cell tray);

a lower level negative cell tray disposed on the bottom current collector assembly (e.g., directly on the lower level battery cell array);

a cooling plate disposed on the bottom current collector assembly (e.g., directly on the lower level negative cell tray);

an upper level negative cell tray disposed on the cooling plate;

an upper level battery cell array disposed on the cooling plate (e.g., on the upper level negative cell tray);

an upper level positive cell tray disposed on the cooling plate (e.g., on the upper level battery cell array); and

a top current collector assembly disposed on the cooling plate (e.g., on the upper level positive cell tray).

Embodiment 2. The battery module according to embodiment 1, further comprising side caps covering respective lateral sides of the lower level positive cell tray, the lower level battery cell array, the lower level negative cell tray, the upper level negative cell tray, the upper level battery cell array, and the upper level positive cell tray.

Embodiment 3. The battery module according to embodiment 2, wherein the side caps are scalloped side caps.

Embodiment 4. The battery module according to any of embodiments 1-3, further comprising main terminal holders on respective ends of the battery module.

Embodiment 5. The battery module according to any of embodiments 1-4, further comprising an upper level center fastener that goes through respective holes of the top current collector assembly, the upper level positive cell tray, the upper level battery cell array, and the upper level negative cell tray.

Embodiment 6. The battery module according to embodiment 5, wherein the upper level center fastener is an upper level center bolt.

Embodiment 7. The battery module according to any of embodiments 1-6, further comprising a lower level center fastener that goes through respective holes of the bottom current collector assembly, the lower level positive cell tray, the lower level battery cell array, and the lower level negative cell tray.

Embodiment 8. The battery module according to embodiment 7, wherein the lower level center fastener is a lower level center bolt.

Embodiment 9. The battery module according to any of embodiments 1-8, comprising a stacked structure of (in order) the bottom current collector assembly, the lower level positive cell tray, the lower level battery cell array, the lower level negative cell tray, the cooling plate, the upper level negative cell tray, the upper level battery cell array, the upper level positive cell tray, and the top current collector assembly.

Embodiment 10. The battery module according to any of embodiments 1-8, comprising a stacked structure of (in order) the bottom current collector assembly, the lower level negative cell tray, the lower level battery cell array, the lower level positive cell tray, the cooling plate, the upper level positive cell tray, the upper level battery cell array, the upper level negative cell tray, and the top current collector assembly.

Embodiment 11. The battery module according to any of embodiments 1-9, wherein:

the lower level positive cell tray is disposed directly on and in direct contact with (e.g., with only an adhesive therebetween or in direct physical contact with) the bottom current collector assembly;

the lower level battery cell array is disposed directly on and in direct contact with (e.g., with only an adhesive therebetween or in direct physical contact with) the lower level positive cell tray;

the lower level negative cell tray is disposed directly on and in direct contact with (e.g., with only an adhesive therebetween or in direct physical contact with) the lower level battery cell array;

the cooling plate is disposed directly on and in direct contact with (e.g., with only an adhesive therebetween or in direct physical contact with) the lower level negative cell tray;

the upper level negative cell tray is disposed directly on and in direct contact with (e.g., with only an adhesive therebetween or in direct physical contact with) the cooling plate;

the upper level battery cell array is disposed directly on and in direct contact with (e.g., with only an adhesive therebetween or in direct physical contact with) the upper level negative cell tray;

the upper level positive cell tray is disposed directly on and in direct contact with (e.g., with only an adhesive therebetween or in direct physical contact with) the upper level battery cell array; and

the top current collector assembly is disposed directly on and in direct contact with (e.g., with only an adhesive therebetween or in direct physical contact with) the upper level positive cell tray.

Embodiment 12. The battery module according to any of embodiments 1-11, wherein each battery module of the plurality of battery modules further comprises a single center fastener (e.g., center tube and/or center bolt assembly) that goes through respective holes of the top current collector assembly, the upper level positive cell tray, the upper level battery cell array, the upper level negative cell tray, the cooling plate, the lower level negative cell tray, the lower level battery cell array, the lower level positive cell tray, and the bottom current collector assembly to clamp the entire battery module together.

Embodiment 13. The battery module according to any of embodiments 1-12, wherein the cooling plate comprises a top plate.

Embodiment 14. The battery module according to any of embodiments 1-13, wherein the cooling plate comprises grooves, dimples, and/or other indentations or protrusions on an upper and/or lower surface thereof.

Embodiment 15. The battery module according to any of embodiments 1-14, wherein the cooling plate comprises at least one end protrusion protruding from an end thereof and having a post extending upwards therefrom.

Embodiment 16. The battery module according to embodiment 15, wherein the cooling plate comprises a connector disposed on the post.

Embodiment 17. The battery module according to any of embodiments 1-16, wherein the cooling plate comprises a first end protrusion protruding from a first end thereof and having a first post extending upwards therefrom, and a second end protrusion protruding from a second end thereof (opposite from the first end) and having a second post extending upwards therefrom.

Embodiment 18. The battery module according to embodiment 17, wherein the cooling plate comprises a first connector disposed on the first post and a second connector disposed on the second post.

Embodiment 19. The battery module according to any of embodiments 1-18, further comprising at least one vertical interconnection (e.g., at an end thereof, in a width-wise direction in which the side caps extend, and which can be used to connect to at least one conductive line of a battery pack that can electrically connect the battery module or to another battery module).

Embodiment 20. The battery module according to any of embodiments 1-19, wherein the cooling plate has width-wise symmetry (in the x-direction as depicted in the figures).

Embodiment 21. The battery module according to any of embodiments 1-20, wherein the cooling plate has length-wise symmetry (in the y-direction as depicted in the figures).

Embodiment 22. The battery module according to any of embodiments 1-21, wherein a width of the battery module (measured in a direction in which the side caps run) is in a range of from 0.5 feet to 2.5 feet.

Embodiment 23. The battery module according to any of embodiments 1-22, wherein a length of the battery module (measured in a direction perpendicular to that in which the side caps run and parallel to an upper surface of the cooling plate) is in a range of from 0.5 feet to 2 feet.

Embodiment 24. The battery module according to any of embodiments 1-23, wherein a thickness of the battery module (measured in a direction perpendicular to an upper surface of the cooling plate) is in a range of from 2 inches to 24 inches (e.g., from 2 inches to 12 inches or from 2 inches to 8 inches).

Embodiment 25. A method of providing battery power to an electric passenger vehicle, the method comprising:

providing a battery module according to any of embodiments 1-24 to the electric passenger vehicle; and

connecting the battery module to the electric passenger vehicle such that the battery module provides battery power to the electric passenger vehicle.

Embodiment 26. A method of fabricating a battery module for an electric passenger vehicle, the method comprising:

forming a bottom current collector assembly;

forming a lower level positive cell tray;

forming a lower level battery cell array;

forming a lower level negative cell tray;

forming a cooling plate;

forming an upper level negative cell tray;

forming an upper level battery cell array;

forming an upper level positive cell tray;

forming a top current collector assembly;

disposing the lower level positive cell tray on the bottom current collector assembly;

disposing the lower level battery cell array on the bottom current collector assembly (e.g., directly on the lower level positive cell tray);

disposing the lower level negative cell tray on the bottom current collector assembly assembly (e.g., directly on the lower level battery cell array);

disposing the cooling plate on the bottom current collector assembly (e.g., directly on the lower level negative cell tray);

disposing the upper level negative cell tray on the cooling plate (e.g., on the upper level negative cell tray);

disposing the upper level battery cell array on the cooling plate (e.g., on the upper level negative cell tray);

disposing the upper level positive cell tray on the cooling plate (e.g., on the upper level battery cell array); and

disposing the top current collector assembly on the cooling plate (e.g., on the upper level positive cell tray).

Embodiment 27. The method according to embodiment 26, wherein the battery module has any of the additional features recited in any of embodiments 2-24.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A battery module, comprising:
a bottom current collector assembly;
a lower level positive cell tray disposed on the bottom current collector assembly;
a lower level battery cell array disposed on the bottom current collector assembly;
a lower level negative cell tray disposed on the bottom current collector assembly;
a cooling plate disposed on the bottom current collector assembly;
an upper level negative cell tray disposed on the cooling plate;
an upper level battery cell array disposed on the cooling plate;
an upper level positive cell tray disposed on the cooling plate; and
a top current collector assembly disposed on the cooling plate.

2. The battery module according to claim 1, further comprising side caps covering respective lateral sides of the lower level positive cell tray, the lower level battery cell array, the lower level negative cell tray, the upper level negative cell tray, the upper level battery cell array, and the upper level positive cell tray.

3. The battery module according to claim 2, wherein the side caps are scalloped side caps.

4. The battery module according to claim 1, further comprising main terminal holders on respective ends of the battery module.

5. The battery module according to claim 1, further comprising an upper level center fastener that goes through respective holes of the top current collector assembly, the upper level positive cell tray, the upper level battery cell array, and the upper level negative cell tray.

6. The battery module according to claim 5, wherein the upper level center fastener is an upper level center bolt.

7. The battery module according to claim 1, further comprising a lower level center fastener that goes through respective holes of the bottom current collector assembly, the lower level positive cell tray, the lower level battery cell array, and the lower level negative cell tray.

8. The battery module according to claim 7, wherein the lower level center fastener is a lower level center bolt.

9. The battery module according to claim 1, comprising a stacked structure of the bottom current collector assembly, the lower level positive cell tray, the lower level battery cell array, the lower level negative cell tray, the cooling plate, the upper level negative cell tray, the upper level battery cell array, the upper level positive cell tray, and the top current collector assembly.

10. The battery module according to claim 1, wherein:
the lower level positive cell tray is disposed directly on and in direct contact with the bottom current collector assembly;
the lower level battery cell array is disposed directly on and in direct contact with the lower level positive cell tray;
the lower level negative cell tray is disposed directly on and in direct contact with the lower level battery cell array;
the cooling plate is disposed directly on and in direct contact with the lower level negative cell tray;
the upper level negative cell tray is disposed directly on and in direct contact with the cooling plate;
the upper level battery cell array is disposed directly on and in direct contact with the upper level negative cell tray;
the upper level positive cell tray is disposed directly on and in direct contact with the upper level battery cell array; and
the top current collector assembly is disposed directly on and in direct contact with the upper level positive cell tray.

11. The battery module according to claim 1, wherein the cooling plate comprises a top plate.

12. The battery module according to claim 1, wherein the cooling plate comprises grooves and dimples on an upper surface thereof.

13. The battery module according to claim 1, wherein the cooling plate comprises a first end protrusion protruding from a first end thereof and having a first post extending upwards therefrom, and a second end protrusion protruding from a second end thereof, opposite from the first end, and having a second post extending upwards therefrom.

14. The battery module according to claim 13, wherein the cooling plate comprises a first connector disposed on the first post and a second connector disposed on the second post.

15. The battery module according to claim 1, further comprising at least one vertical interconnection at an end thereof.

16. The battery module according to claim 1, wherein the cooling plate has width-wise symmetry and length-wise symmetry.

17. The battery module according to claim 1, wherein a width of the battery module, measured in a first direction along a longest edge of the upper level positive cell tray, is in a range of from 0.5 feet to 2.5 feet.

18. The battery module according to claim 1, wherein a length of the battery module, measured in a second direction perpendicular to a longest edge of the upper level positive cell tray and parallel to an upper surface of the cooling plate, is in a range of from 0.5 feet to 2 feet.

19. The battery module according to claim 1, wherein a thickness of the battery module, measured in a third direction perpendicular to an upper surface of the cooling plate, is in a range of from 2 inches to 24 inches.

20. A battery module, comprising:
a bottom current collector assembly;
a lower level positive cell tray disposed directly on in direct contact with the bottom current collector assembly;
a lower level battery cell array disposed directly on in direct contact with the lower level positive cell tray;
a lower level negative cell tray disposed directly on in direct contact with the lower level battery cell array;
a cooling plate disposed directly on in direct contact with the lower level negative cell tray;
an upper level negative cell tray disposed directly on in direct contact with the cooling plate;
an upper level battery cell array disposed directly on in direct contact with the upper level negative cell tray;
an upper level positive cell tray disposed directly on in direct contact with the upper level battery cell array;
a top current collector assembly disposed directly on in direct contact with the upper level positive cell tray;
scalloped side caps covering respective lateral sides of the lower level positive cell tray, the lower level battery cell array, the lower level negative cell tray, the upper level negative cell tray, the upper level battery cell array, and the upper level positive cell tray;
main terminal holders on respective ends of the battery module;
an upper level center fastener that goes through respective holes of the top current collector assembly, the upper level positive cell tray, the upper level battery cell array, and the upper level negative cell tray; and
a lower level center fastener that goes through respective holes of the bottom current collector assembly, the lower level positive cell tray, the lower level battery cell array, and the lower level negative cell tray,
wherein the cooling plate comprises a top plate,
wherein the cooling plate comprises grooves and dimples on an upper surface thereof,
wherein the cooling plate comprises a first end protrusion protruding from a first end thereof and having a first post extending upwards therefrom, and a second end protrusion protruding from a second end thereof, opposite from the first end, and having a second post extending upwards therefrom,
wherein the cooling plate comprises a first connector disposed on the first post and a second connector disposed on the second post,
wherein the cooling plate has width-wise symmetry and length-wise symmetry,
wherein a width of the battery module, measured in a first direction along a longest edge of the upper level positive cell tray, is in a range of from 0.5 feet to 2.5 feet,
wherein a length of the battery module, measured in a second direction perpendicular to the first direction and parallel to the upper surface of the cooling plate, is in a range of from 0.5 feet to 2 feet, and
wherein a thickness of the battery module, measured in a third direction perpendicular to the first direction, the second direction, and the upper surface of the cooling plate, is in a range of from 2 inches to 24 inches.
